(19) United States
(12) Patent Application Publication
(10) Pub. No.: US 2003/0018806 A1
(43) Pub. Date: Jan. 23, 2003

(54) Method and message server for conveying messages in a telecommunications network

(76) Inventors: Brian P. Rueger, Kloten (CH); Marc A. Woog, Winkel (CH)

Correspondence Address: Oliff & Berridge, P O Box 19928, Alexandria, VA, 22320, US

(21) Appl. No.: 09/762,110

(22) PCT Filed: Jan. 8, 2001
(86) PCT No.: PCT/CH01/00012

(51) Int. Cl. G06F 15/16; G06F 15/173; H04Q 7/20

(52) U.S. Cl. 709/238; 455/466; 709/249

(57) ABSTRACT

The method, message server and the telecommunications network allow to convey messages, particularly short messages, originating in a mobile telecommunications network such as the GSM system and terminating at a recipient application or a related service in an IP network not using the standards of said mobile telecommunications network. The inventive telecommunications network comprises a message server (WAMS) through which messages arriving at a first service centre (SC2) can be routed to a second service centre (SC1) which is connected to the recipient application or the related service. According to the inventive method a virtual mobile station number is established as the address for the recipient application, to which the entire community of short message mobile stations MS can originate messages as it would originate them towards a real mobile station MS.

The present invention relates to a method for conveying messages in a telecommunication network, to a message server and to a telecommunications network according to claim 1 respective claim 9 and claim 12. More particularly the present invention relates to a method for conveying messages originating in a mobile telecommunications network for example as specified in the GSM (Global System for Mobile Communications) standards, the TDMA standards, the CDMA standards, the 3G standards (MMS) as well as in the Signalling System No. 7, IS-41 and IS-95 protocol standards and terminating in a network not using said standards but, for example, using the internetworking protocols TCP/IP instead. Networks using the internetworking protocols TCP/IP are the Internet, or corporate Intranets or Extranets. The term message used in this document particularly relates to short messages as defined in the above mentioned standards.

### BACKGROUND OF THE INVENTION

modern mobile telecommunications networks such as the Pan-European Cellular System respective the Global System for Mobile Communications GSM allow the transfer of Short Messages between subscribes. An introduction to the GSM system can be found in [1], Lajos Hanzo, THE COMMUNICATIONS HANDBOOK, CRC PRESS, Boca Raton 1997, Chapter 87, pages 1226 ff. Below references are also given to [2], B. Walke, Mobilfunknetze und ihre Protokolle, Band 1, B. G. Teubner Verlag, Stuttgart 2000 and to [3], GSM Specification 03.40 concerning the technical realisation of the Short Message Service (SMS), the latter being herein incorporated by reference in its entirety. The transfer of Short Messages originating in a network working according to TCP/IP internetworking protocols (described in [1], pages 702-704) and transferred and delivered through the CSM system to a subscribers mobile station according to [3], GSM Technical Specification 03.40, is described in [4], U.S. Pat. No. 5,768,509.

The GSM system uses the Signalling System Number 7 which has been enhanced by a Mobile Application Part (MAP) which is specified in [5] GSM Technical Specification 09.02 (Mobile Application Part (MAP) specification) as well as TDMA is enhanced with the IS-41 protocol. A description of Signalling System Number 7 and the IS-41 protocol is given in [1], chapter 35, pages 480 to 495 respective [1], chapter 80.3, pages 1121-1123.

Transfer of short messages is preferably performed in the control channels SDCCH and SACCH (see [3], page 201). The protocol architecture of the Short Message System is shown in [3], chapter 9, page 30.

Transfer of short messages between terminals, mobile stations MS or fixed stations including data terminals, requires a service centre SC which is capable of

a) receiving a short message from a mobile station or over an interface from a data terminal within a TCP/IP network,

b) submitting a Short Message to a mobile station or over an interface from a data terminal within a TCP/IP network and

c) receiving and returning reports relating to sent or received short messages.

Fundamental procedures regarding the transfer of a short message from a service centre SC to a mobile station MS are shown in [3], pages 56 and 57; see also [3], Annex 2.

The short message is forwarded by the service centre SC to a gateway function GMSC which is a function of a mobile services switching centre MSC. The gateway GMSC is capable of interrogating a home location register HLR which contains routing information to the visitor location register VLR. The visitor location register VLR is the functional unit that attends to a mobile station MS operating outside the area of the home location register. A visiting mobile station MS is automatically registered at the nearest mobile services switching centre MSC and the visitor location register VLR is informed accordingly. Based on the retrieved routing information the gateway GMSC forwards the short message to the visited mobile services switching centre MSC. The visited mobile services switching centre MSC retrieves corresponding subscriber information from the visitor location register VLR based on which the short message is forwarded to the mobile station MS. Operations are terminated by returning a delivery report to the service centre SC of the network where the short message has been initiated.

Fundamental procedures regarding the transfer of a short message within a GSM system from a mobile station MS to a service centre SC are shown in [3], pages 64 and 65.

Before a short message is transferred to a mobile services switching centre MSC the mobile services switching centre MSC retrieves information from the visitor location register VLR in order to verify that the requested service is available to the subscriber. Afterwards the short message is transferred via the mobile services switching centre MSC to an interworking function IWMSC belonging to a mobile services switching centre MSC. The interworking function IWMSC is capable of receiving a short message from within the public land mobile network PLMN and submitting it to a service centre SC which will forward the short message to the addressed subscriber as described above.

The mobile station MS will always address the required service centre SC by an E.164 address (see [3], page 24, paragraph 5.2.2). It is important to note that a subscriber with a mobile station MS will usually select the service centre SC of his network operator and not the service centre SC through which a message has been transferred to the subscriber if the message originates in another network. Additionally a subscriber may not be allowed to use a foreign service centre SC for submitting messages, as the respective foreign network operator may enforce this by means of black listing.

Transfer of messages originating in an IP network and being forwarded to a service centre SC will therefore be transferred from the service centre SC to the addressed mobile station MS as described above.

Transfer of messages originated by the mobile station MS to the user/application in the IP network is only possible when the mobile station MS and the IP network are connected to the same mobile network, provided the mobile station MS has rights to use the service centre SC in that network. However, this transfer is not possible when the mobile station MS is operating in another mobile network than the one to which the IP network is connected to, since, as described above the transfer procedures comprise an access to the home location register HLR in order to retrieve the recipients data. Data of Internet-, Intranet- or Extranet users are however not registered in the home location register HLR resulting in a failure of the transaction.

The present invention is therefore based on the object of specifying a method, a message server and a telecommunications network for conveying messages, particularly short messages, originating in a mobile telecommunications network such as the GSM system and terminating in a network, such as an IP network, which is not using the standards of said mobile telecommunications network.

It is another object of the invention to enable a subscriber to a mobile telecommunications network to send messages to a terminal or an application connected to a network using the internetworking protocols TCP/IP or to another connectionless packet switching network.

It is a further object of the invention to provide a message server for handling said messages which can easily be operated and integrated into said telecommunications network.

### SUMMARY OF THE INVENTION

The above and other objects of the present invention are achieved by a method, a message server and a telecommunications network according to claim 1 respective claim 9 respective claim 12.

The inventive method allows to convey messages, particularly short messages, originating in a mobile telecommunications network such as the GSM system and terminating at a recipient application or a related service in an IP network not using the standards of said mobile telecommunications network.

Messages sent within a mobile telecommunications network to a service centre SC which is not linked to the recipient application or a related service are forwarded over a direct path to the inventive message server WAMS (Wireless Application Message Server) which delivers the messages to a service centre SC located in mobile telecommunications network and being linked to the recipient application or a related service.

The messaging services of the mobile telecommunications network is therefore extended to providing messaging channels to users of applications or a related service operating in a network specified for example according to the internetworkinq protocols TCP/IP or other connectionless packet switching networks, across several wireless networks.

The expanded messaging services can be made available to individual subscribers or commercial providers which can open an account at a service centre SC. Individual subscribers will preferably use the services of commercial providers which take care of negotiations with the network operators.

The message server WAMS uses signalling functions, such as the functions of the Signalling System Number 7, according to the standards of said mobile telecommunications network and can therefore easily be incorporated into the mobile telecommunications network. No proprietary transactions are used at the interface level between the inventive message server WAMS and the mobile telecommunications network, so as to use the full potential of the capabilities of the mobile telecommunications network and to minimise cost of the realisation and integration of the inventive solution. This in parallel results also in small cost for operation and maintenance.

The message server preferably handles the recipient applications or the related services as virtual mobile stations thus facilitating signalling operations.

The inventive telecommunications network realised with the integration of the inventive message server within one mobile telecommunications network may incorporate several public land mobile networks PLMN connected to connection oriented or connectionless packet switching or circuit switched networks.

### BRIEF DESCRIPTION OF THE DRAWINGS

Some of the objects and advantages of the present invention have been stated, others will appear when the following description is considered together with the accompanying drawings, in which:

FIG. 1 shows a known telecommunications network designed to convey messages originating in the Internet or an Intranet and terminating in mobile stations of a first or a second public land mobile network PLMN;

FIG. 2 shows the inventive telecommunications network capable of conveying messages originating in mobile stations of a first or a second public land mobile network PLMN and terminating in the Internet or an Intranet;

FIG. 3 shows the protocol layers of the signalling system No. 7 used in a GSM system for a home location register HLR and for a mobile switching services centre MSC;

FIG. 4 shows the transactions performed for transferring a message from a first service centre SC over the inventive message server to a second service centre Sc.

### DETAILED DESCRIPTION OF THE PREFERRED EMBODIMENTS

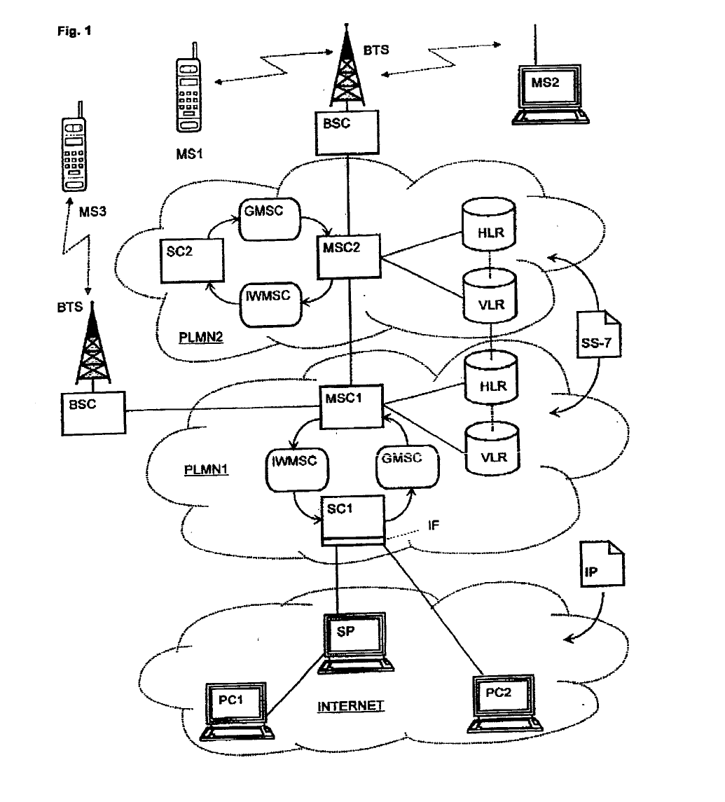

FIG. 1 shows a known telecommunications network designed to convey messages originating in the Internet or an Intranet and terminating in mobile stations of a first or a second public land mobile network PLMN1 respective PLMN2. The structure of a GSM public land mobile network PLMN is shown and described in [1], pages 1226 to 1228. For TDMA systems using the IS-41 protocol and CDMA systems using the IS-95 protocol see [1], chapter 80.3, pages 1121-1123 respective [1], chapter 89, pages 1257-1263.

A GSM public land mobile network can be viewed as a configuration comprising

a) a user level with voice and data terminals mS1, MS2, MS3, PC1, PC2 and SP;

b) a network level with mobile services switching centres MSC1, MSC2; short message service centres SC1, SC2; gateway functions GMSC and interworking functions IWMSC belonging to a mobile services switching centre MSC and base station tranceivers BTS and thereto related base Station controllers BSC;

c) a database level with home location registers HLR, visitor location registers VLR and Equipment Identity registers (not shown as this optional network entity is not relevant for the scope of this document) and

d) a signalling level working according to the Signalling System No. 7 with signalling points connected to the elements of the database level and with signalling points connected to the switching elements of the network layer.

In a different view the mobile stations MS, the base station tranceivers BTS and thereto related base station controllers BSC are contained in a Radio Subsystem, the mobile services switching centres MSC1, MSC2; short message service centres SC1, SC2; gateway functions GMSC and interworking functions IWMSC as well as the home location and visitor location registers HLR, VLR are contained in a Network and Switching Subsystem NSS and a Operation and Maintenance Centre (not shown), an Authentication Centre (not shown) and an Equipment Identity Register (not shown) are contained in an operation Subsystem.

Fundamental procedures regarding the transfer of a short message from a mobile station MS to a service centre SC and from the service centre SC to a mobile station MS were described above.

The service centre SC1 shown in FIG. 1 may as described in [4] be a work station comprising a memory to store short messages and subscriber data. The service centre SC1 is over a gateway and an interworking functions on one side connected to the mobile switching services centre MSC1. On the other side over a TCP/IP interface IF the service centre SC1 is connected to Internet or Intranet network entities SP and PC2 which comprise services and applications capable of sending messages to the service centre SC1 where the addresses of said services and application are stored in a database. Preferably individual subscribers PC1 access the service centre SC1 over a service provider SP.

As mentioned above messages can be sent in the telecommunication network shown in FIG. 1 from the Internet network entities SP, PC1 and EC2 over the public land mobile network PLMN1 and PLMN2 to the mobile stations MS1, MS2 and MS3. On the reply path, described in [3], Annex 4, the service centre SC1 will also receive a delivery report. Mobile stations MS1, MS2 and MS3 which are not registered at the service centre SC1 will however not be able to initiate or return in reply a message to the Internet or Intranet network entities SP, PC1 and PC2 since the service centre SC2 in the public land mobile network PLMN2 in which the mobile stations MS1, MS2 and MS3 are registered for example, does not have access to address or routing information for the Internet network entities SP, PC1 and PC2.

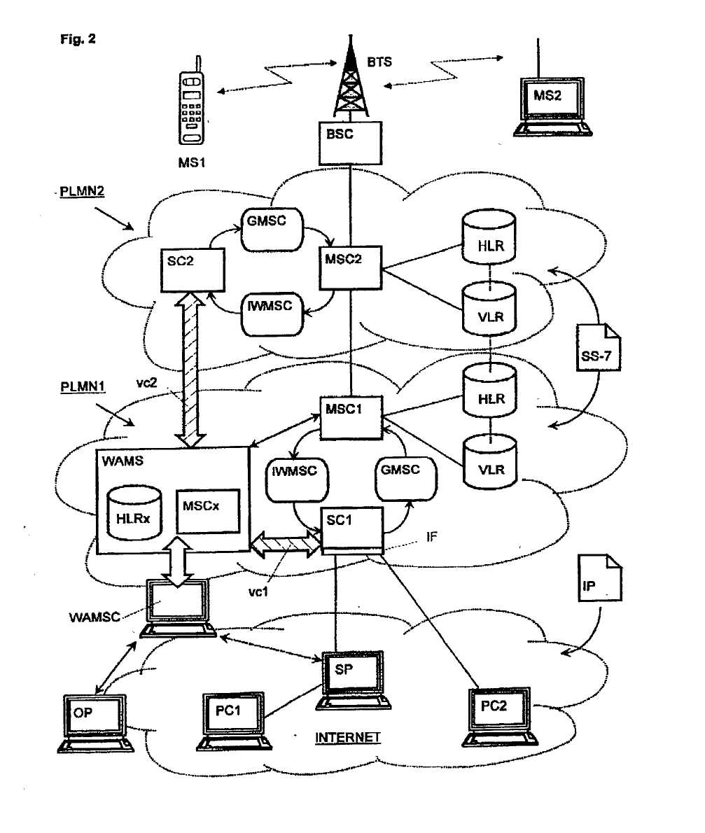

FIG. 2 shows the inventive telecommunications network capable of conveying messages originating in mobile stations MS1 and MS2 of a first or a second public land mobile network PLMN1, PLMN2 and terminating in the Internet or in an Intranet.

As drawn in FIG. 2 the inventive solution is based on the idea of forwarding the messages from the first service centre SC2 accessed by the mobile stations MS1 and MS2 over a message server WAMS to the second service centre SC1 on a path shown with virtual connections vc1 and vc2.

The inventive solution is further based on the idea of representing applications to which messages are sent, afterwards called recipient applications, as virtual mobile stations equipment with virtual mobile address information such as a virtual mobile station number respective a Mobile Station International ISDN Number (MSISDN) and a corresponding International Mobile Station Identity (IMSI).

Hence any mobile station MS in a first or second public land mobile network PLMN1, PLMN2 is able to directly exchange messages with recipient applications located within a TCP/IP network connected to one of the public land mobile networks PLMN1, PLMN2 as if said mobile stations MS were exchanging messages with any other mobile stations MS of said networks PLMN1, PLMN2.

Messages sent by the mobile stations MS1 and MS2 to said virtual mobile stations are forwarded to the message server WAMS where corresponding address information of the recipient application and the service centre SC1 connected thereto is retrieved. Said address information preferably comprises the E.164 address of the service centre SC1 and the address and preferably address type of the recipient application or a related service.

Based on the retrieved information the message is forwarded from the message server WAMS to the service centre SC1.

In order to store the above mentioned address information the message server WAMS comprises a database HLRx and switching function MSCx which towards the mobile telecommunications network act as a standard home location register HLR respective as standard mobile services switching centre MSC and which are therefore accessible by means of the signalling system (Signalling System No. 7) from all other entities of the interconnected mobile telecommunications network which act as signalling points.

The above described address information (virtual subscriber number, IMSI, E.164 address of the service centre SC1 and the application or service number) required for the transfer of messages are updated ill the database HLRx by means of a control unit WAMSC such as a workstation. Maintenance of the data in the database HLRx may also be performed by means of a workstation OP of an Operator. In a preferred embodiment the data in the database HLRx may be maintained by the service provider SP.

In order to send a message to an Internet network entity SP, PC1 and PC2 the user of a mobile station NS1, MS2 needs to know only the virtual mobile station number of the recipient application.

The procedures for the transfer of a message from a mobile station MS to a service centre SC which are also used by the inventive solution have been described above. The inventive solution, which takes care that the message arriving at a service centre SC2 selected by the corresponding subscriber as the default service centre will be forwarded to the service centre SC1 linked to the recipient address, will be described for a mobile telecommunications network using the Signalling System No. 7 in detail below.

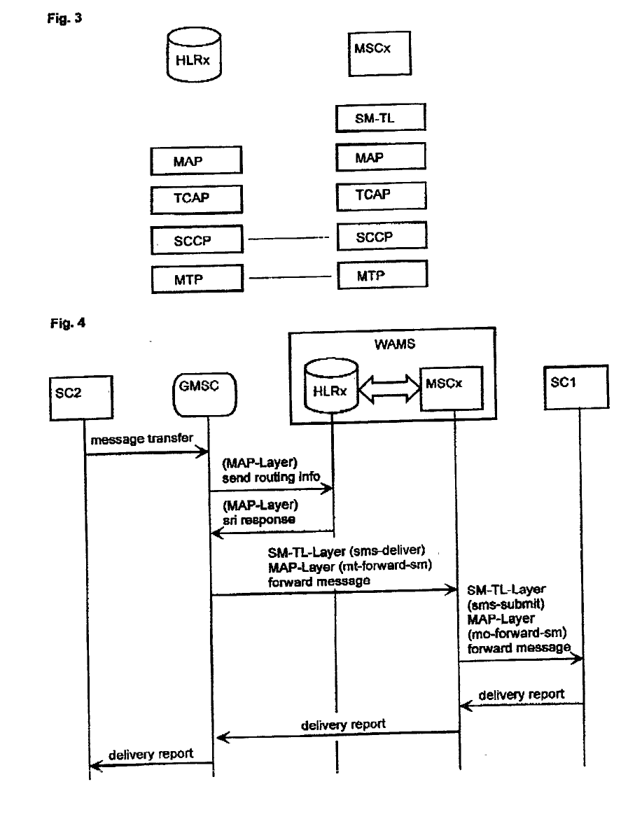

FIG. 3 shows the protocol layers of the Signalling System No. 7 used in a GSM system for home location registers HLR and for mobile switching services centres MSC. Signalling System No.7 is an out-of-band signalling concept which was designed to control telephone switching equipment within the Integrated Services Digital Network (ISDN). Signalling The protocol architecture of Signalling System No.7 comprises

a) a Message Transfer Part MTP consisting from bottom to top of

a1) Signalling Data Link Functions (MTP Level 1) corresponding to Layer 1 of the OSI Model,

a2) Signalling Link Functions (MTP Level 2) corresponding to Layer 2 of the OSI Model and

a3) Signalling Network Functions (MTP Level 3) corresponding to a first part of Layer 3 of the OSI Model:

b) a Signalling Connection Control Part (SCCP) enhancing the functions of MTP Level 3 in order to provide the functional equivalent of OIS's network layer 3 and

c) application protocols (corresponding to Layer 7 applications of the OSI Model) such as the Transaction Capabilities Application Part (TCAP) which provides services for User Parts such as the Mobile Application Part (MAP) which was created fur the GSM system.

The procedures specified in the protocols of the above mentioned layers (MTP, SCCP, TCAP and MAP) arc sufficient to enable communication with a home location register HLR as well as the database HLRx of the message server WAMS (the database HLRx, which has been extended for the purposes described herein, is a true home location register HLR, supporting all the external queries typical for a standard home location register HLR).

In order to enable subscribers of the GSM system to exchange short messages the protocols of the Short Message Transfer Layer SM-TL have been created. The services provided by the Short Message Transfer Layer SM-TL enable the application layer above to transfer short messages to its peer entities. The Short Message Transfer Layer SM-TL comprises Protocol Data Units PDU:

SMS-DELIVER conveying a short message from the service centre SC to the mobile station MS,

SMS-SUBMIT conveying a short message from the mobile station MS to the service centre SC,

SMS-COMMAND conveying a command from the mobile station MS to the service centre SC

and SMS-DELIVER-REPORT, SMS-SUBMIT-REPORT, SMS-STATUS-REPORT.

FIG. 4 shows the transactions performed for transferring a message from a first service centre SC2 over the inventive message server WAMS to a second service centre SC1. Assuming that service centre SC2 has received a message according to the procedures described above it either forwards the message directly to an addressed mobile station MS or, in case that the message should reach a recipient application, the message is forwarded based on a contained virtual mobile station number (MSISDN) as destination address to the message server WaMS. Based on the information in the database HLRx of the message server WAMS address data corresponding to the virtual mobile station number is retrieved and used for the forwarding of the message as a new destination address. The message is therefore forwarded to the service centre SC1 whose address has been retrieved from the database HLRX with the destination address of the recipient application or a related service.

With the MAP-layer commands SEND ROUTING INFO and SEND ROUTING INFO response the service centre SC2 respective a related gateway function GMSC retrieves routing information from the database HLRx based on which the message is delivered to the switching functions MSCx by means of an SMS-DELIVER protocol data unit.

The switching function MSCX of the message server is addressable like a standard mobile services switching centre MSC. Whenever the service centre SC2 needs to deliver a message it will first query the database HLRX with the virtual mobile station number respective the Mobile Station International ISDN Number (MSISDN) in order to obtain the International Mobile Station Identity (IMSI) and the address of the mobile services switching centre respective the switching function MSCx which is serving the addressed object (a recipient application instead of an actual mobile station MS). Subsequently the message is delivered with said SMS-DELIVER protocol data unit comprising as RP-DESTINATION-ADDRESS the International Mobile Station Identity (IMSI).

The switching function MSCX will translate the International Mobile Station Identity (IMSI) to the address of the recipient application on the hosting service centre SC1 to which the message is forwarded by means of an SMS-SUBMIT protocol data unit. The SM-TL-layer SMS-DELIVER event is therefore changed into an SM-TL-layer SMS-SUBMIT event as otherwise the addressed service centre SC would reject the message. Based on the address of the recipient application the message can be terminated in a way as it would be done on the reply path (see [3], Annex 4).

Based on the inventive idea of using virtual mobile station numbers it would be possible to use different routing procedures in the message server WAMS. However the described mode of the invention avoids proprietary functions which would be time consuming to implement.

[1] THE COMMUNICATIONS HANDBOOK, CRC PRESS, Boca Raton 1997

[2] B. Walke, Mobilfunknetze und ihre Protokolle, Band 1, B. G. Teubner Verlag, Stuttgart 2000

[3] GSM Specification 03.40 concerning the technical realisation of the Short Message Service (SMS) respective ETSI European Telecommunication Standard ETS 300 536 (October 1994)

[4] U.S. Pat. No. 5,768,509 (Gunluk)

[5] GSM Tecinical Specification 09.02 (Mobile Application Part (MAP) specification) respective ETSI European Telecommunication Standard ETS 300 599 (February 1995)

1. A method for conveying messages, particularly short messages, originating in a mobile telecommunications network such as a GSM, TDMA, CDMA or 3G (MMS) system and terminating at a recipient application or a related service in a network such as an IP network which is not using the standards of said mobile telecommunications network comprising the steps of
a) providing a message server (WAMS) using signalling functions, such as the functions of the Signalling System Number 7, according to the standards of said mobile telecommunications network;
b) providing a database (HLRx) in said message server (WAMS) comprising routing information to said recipient application or the related service;
c) providing a switching function (MSCX) for transferring messages according to retrieved routing information;
d) an originating mobile station (MS) selecting an address of said message server (WAMS) as destination address which corresponds to a recipient application;
e) transmitting the message to a first service centre (SC2)in the mobile telecommunications network;
f) the first service centre (SC2) using a related gateway function (GMSC) for retrieving routing information from the database (HLRx) of the message server (WAMS) based on the provided destination address and
g) forwarding the message through the switching function (MSCx) in the message server (WAMS) to a second service centre (SC1) hosting the recipient application or the related service

2. Method according to claim 1, in which numbers of virtual mobile stations having preferably the format of a standardised E.164 address numbers are assigned to the recipient applications which virtual mobile station numbers are used as a destination address in order to access the message server (WAMS) respective its elements (HLRx, MSCx).

3. Method according to claim 1 or 2, in which the information such as the virtual mobile station number used to access the message server (WAMS) respective its functions (HLRx, MSCX) is originally provided in the user data or the signalling data, particularly as the originating address, of a former message sent by the recipient application or a related service.

4. Method according to claim 1, 2 or 3, in which the service related to the application is a messenger service sending messages from related applications to a service centre (SC1) and receiving messages from the service centre (SC1) and distributing the received messages to the related applications.

5. Method according to one of the claims 1 to 4, in which the message server (WAMS) handles the recipient applications or the related services as virtual mobile stations with the database (HLRx) of the message server (WAMS) containing at least
a) a Mobile Station International ISDN Number (MSISDN) serving as the virtual mobile station number related to the recipient application or the related service,
b) the International Mobile Station Identity (IMSI) corresponding to said Mobile Station International ISDN Number (MSISDN),
c) the address, such as an E.164 address, of the service centre (SC1) linked to the recipient application or the related service,
d) the address and preferably address type of the recipient application or the related service.

6. Method according to claim 5, in which
a) the first service centre (SC2) respective the related gateway function (GMSC) uses the Mobile Station International ISDN Number (MSISDN) for retrieving the international Mobile Station Identity (IMSI) and the address of the switching function (MSCX) from the database (HLRx) of the message server (WAMS) preferably by means of a SEND ROUTING INFO query,
b) the first service centre (SC2) respective the related gateway function (GMSC) forwards the message to the switching function (MSCX) of the message server (WAMS) and
c) the switching function (MSCX) retrieves the address of the recipient application or the related service as well as the address of the service centre (SC1) linked to the recipient application or the related service and submits the message preferably with an SMS-SUBMIT event instead of an SMS-DELIVER event to the addressed service centre (SC1) and
d) the addressed service centre (SC1) based on routing information stored in a database forwards the message to the recipient application or a related service.

7. Method according to one of the claims 1 to 6, in which the database (HLRx) of the message server (WAMS) is maintained by an operator (OP; SP) of a service provider such as the service provider SP related to said application and service.

8. Method according to one of the claims 1 to 6, in which transactions performed by said message server (WAMS) are counted and reported.

9. Message server (WAMS) for conveying messages, particularly short messages, originating in a mobile telecommunications network such as the GSM system and terminating at a recipient application or a related service in a network such as an IP network which is not using the standards of said mobile telecommunications network, said message server (WAMS)
a) using signalling functions, such as the functions of the Signalling System Number 7, according to the standards of said mobile telecommunications network;
b) comprising a database (HLRx) containing routing information to said recipient application or the related service which is retrievable by a service centre (Sc2);
c) comprising a switching function (MSCX) for transferring messages received from said service centre (SC2) according to the retrieved routing information and
d) comprising a control unit (WAMSC) through which an operator can access and update at least said database (HLRx).

10. Message server (WAMS) according to claim 9 in which the database (HLRx) contains at least
a) the Mobile Station International ISDR Number (MSISDN) related to the recipient application or the related service,
b) the International Mobile Station Identity (IMSI) corresponding to said Mobile Station International ISDN Number (MSISDN),
c) the address, such as an E.164 address, of the service centre (SC1) linked to the recipient application or the related service,
d) the address and preferably address type of the recipient application or the related service.

11. Message server (WAMS) according to claim 9 or 10 in which the database (HLRx) operates according to the specification of a home location register (HLR) of a GSM system and in which the switching function (MSCX) operates according to the specification of a mobile services switching centre (MSC) of a GSM system.

12. Telecommunications network for conveying messages, particularly short messages, originating in a mobile telecommunications network such as the GSM system and terminating at a recipient application or a related service in a network not using the standards of said mobile telecommunications network, comprising a message server (WAMS) according to one of the claims 9 to 11, through which messages arriving at a first service centre (SC2) can be routed to a second service centre (SC1) which is linked to the recipient application or the related service.
